(19) United States
(12) Patent Application Publication
(10) Pub. No.: US 2017/0064174 A1
(43) Pub. Date: Mar. 2, 2017

(54) IMAGE SHOOTING TERMINAL AND IMAGE SHOOTING METHOD

(71) Applicant: YULONG COMPUTER TELECOMMUNICATION SCIENTIFIC (SHENZHEN) CO., LTD., Nanshan Shenzhen (CN)

(72) Inventor: Lifeng XIAO, Nanshan Shenzhen (CN)

(73) Assignee: YULONG COMPUTER TELECOMMUNICATION SCIENTIFIC (SHENZHEN) CO., LTD., Nanshan Shenzhen (CN)

(21) Appl. No.: 15/348,380

(22) Filed: Nov. 10, 2016

Related U.S. Application Data
(63) Continuation-in-part of application No. PCT/CN2015/071999, filed on Jan. 30, 2015.

(30) Foreign Application Priority Data
Apr. 24, 2014 (CN) 201410168108.1

(51) Int. Cl. H04N 5/225; G06T 11/60

(52) U.S. Cl. CPC H04N 5/2258; G06T 11/60; G06T 2207/20221

(57) ABSTRACT

Disclosed are a terminal and method for image shooting, the terminal includes at least one processor; and a memory communicably connected with the processor for storing instructions executable by the processor; where execution of the instructions by the at least one processor causes the at least one processor to: control at least two cameras with different zoom ratios to shoot a scenario; determine image regions corresponding to an image with a predetermined zoom ratio in images with different zoom ratios obtained by the at least two cameras according to the predetermined zoom ratio when controlling the at least two cameras to shoot a same scenario and when an image to be obtained has a predetermined zoom ratio greater than a zoom ratio of any of the cameras; and synthesize image regions corresponding to the image with the predetermined zoom ratio determined in images with different zoom ratios.

### CROSS-REFERENCES TO RELATED APPLICATIONS

This application is a continuing-in-part application of a PCT application No. PCT/CN2015/071999, filed on Jan. 30, 2015; and claims the priority of Chinese patent application No. 201410168108.1, filed on Apr. 24, 2014 to State Intellectual Property Office, the disclosures of which are hereby incorporated by reference in its entirety.

### TECHNICAL FIELD

The present disclosure relates to the field of terminal shooting, and particularly to an image shooting terminal which is capable of obtaining a larger zoom ratio and having a smaller thickness and an image shooting method.

### BACKGROUND

Optical zoom is generated through position changes of three parts including a camera shot, an object and a focus. When an imaging plane moves in a horizontal direction, a viewing angle and a focal distance are changed; and farther scenes become clearer, making people feel that objects are progressive . It is apparent that there will surely be two ways to change the viewing angle. One way is to change the focal distance of the camera shot, i.e., optical zoom. The focal distance of the camera shot is changed by changing the relative position of each lens in a zoom camera shot. The other way is to change a size of the imaging plane, i.e., a length of a diagonal line of the imaging plane, this is called digital zoom in digital photography. In fact, the focal distance of the camera shot is not changed in digital zoom, and the viewing angle is changed only by changing an angle of the diagonal line of the imaging plane, so as to generate an effect “equivalent to” the change of the focal distance of the camera shot. Therefore, compared with the digital zoom with a same zoom ratio, the optical zoom has a better image effect.

The longer the camera shot of a digital camera, the larger a movement space of internal lenses and a photosensor, so the zoom ratio is larger. Therefore, to obtain optical zoom of a higher zoom ratio, a camera generally has a large thickness, and for example, the camera is made as an extended camera shot or a periscopic camera shot. An existing periscopic camera shot and an extended camera shot are used in terminals such as mobile phones. A shape of a mobile phone cannot be made to be thinner after a camera shot is installed in the mobile phone due to complicated structures of the camera shot, expensive price and larger volume, so requirements of thinning to terminals such as mobile phones cannot be realized. In addition, performance failure is easily caused by knocking when a camera shot and optical components are used in terminals such as mobile phones due to complicated structures of a camera shot, non-resistance to falling for optical components, so that the periscopic camera shot and the extended camera shot cannot be popular for a long period of time.

Thus, how to provide an image shooting terminal which is capable of obtaining a larger zoom ratio with a smaller thickness and an image shooting method is a technical problem needed to be solved by those skilled in the art.

### SUMMARY

The present disclosure provides an image shooting terminal and an image shooting method for solving a problem in an existing technology that a thickness of a camera module is increased when a picture with a higher zoom ratio is provided.

To achieve the above purpose, the present disclosure provides an image shooting terminal and an image shooting method.

In a first aspect, an image shooting terminal includes:
at least one processor; and
a memory communicably connected with the at least one processor for storing instructions executable by the at least one processor;
wherein, execution of the instructions by the at least one processor causes the at least one processor to:
control at least two cameras with different zoom ratios to shoot the scenario;
determine image regions corresponding to an image with a predetermined zoom ratio in images with different zoom ratios obtained by the at least two cameras according to the predetermined zoom ratio when controlling the at least two cameras with different zoom ratios to shoot a same scenario and when an image to be obtained has a predetermined zoom ratio greater than a zoom ratio of any of the cameras; and
synthesize image regions corresponding to the image with the predetermined zoom ratio determined in images with different zoom ratios, so as to obtain an image with the predetermined zoom ratio.

In a second aspect, an image shooting method includes:
controlling at least two cameras with different zoom ratios of an image shooting module to synchronously shoot to respectively obtain images with different zoom ratios;
determining image regions corresponding to an image with a predetermined zoom ratio in images with different zoom ratios according to the predetermined zoom ratio of an image to be obtained, where the predetermined zoom ratio is greater than a zoom ratio of any of the cameras of the image shooting module; and
synthesizing an image with the predetermined zoom ratio according to image regions corresponding to images with the predetermined zoom ratio obtained in images with different zoom ratios.

In a third aspect, an image shooting method includes:
selecting a predetermined zoom ratio of an image to be obtained;
controlling an image shooting module to shoot according to the selected predetermined zoom ratio; and
determining image regions corresponding to the image with the predetermined zoom ratio in images with different zoom ratios according to the predetermined zoom ratio of the selected and obtained image when the predetermined zoom ratio is greater than a zoom ratio of any of the cameras of the image shooting module.

### DESCRIPTION OF THE DRAWINGS

FIG. 1 is a structural block diagram showing an image shooting terminal provided in embodiments of the technical solution;

FIG. 2 is a flow chart showing an image shooting method provided in one embodiment of the technical solution;

FIG. 3 is a flow chart showing an image shooting method provided in another embodiment of the technical solution; and

FIG. 4 is a schematic diagram illustrating a hardware structure of an image shooting terminal for shooting image in one embodiment of the technical solution.

### DETAILED DESCRIPTION

To make purpose, technical solution and advantages of the present disclosure more clear, the present disclosure will be further described below in detail in combination with drawings and embodiments. It should be understood that specific embodiments described herein are only configured to explaining the present disclosure, not configured to limiting the present disclosure.

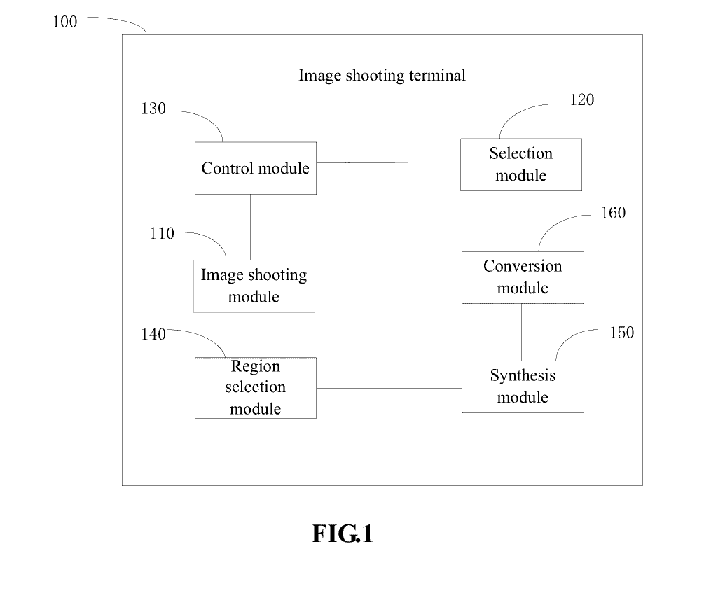

With reference to FIG. 1, a first embodiment of the present disclosure provides an image shooting terminal 100. The image shooting terminal 100 may be a smart device such as a mobile phone, a tablet personal computer. Shooting involved in the present disclosure is not limited to photo shooting, video shooting, etc., and will be described below by using photo shooting as an example. Video shooting means that a plurality of photos are synthesized in a time sequence, that is, the present disclosure is also suitable for video shooting.

The image shooting terminal 100 includes an image shooting module 110, a selection module 120, a control module 130, a region selection module 140, a synthesis module 150 and a conversion module 160.

The image shooting module 110 may be a camera module portion in terminals such as a mobile phone, and is configured to perform image sampling (such as photo shooting, video recording, etc.) on an external scenario. The image shooting module 110 includes at least two cameras, and at least two cameras have different zoom ratios. Resolution of each camera may be identical or different.

In the present embodiment, the image shooting module 110 includes two cameras; one camera is a camera with lx zoom and the other camera is a camera with 2× zoom. The two cameras have a same resolution. The two cameras are adjacently arranged. Under a condition that a manufacturing process permits, a distance between the two cameras may be as short as possible, so that images shot by the two cameras can be matched as much as possible when the two cameras shoot a same scenario. The two cameras of the image shooting module 110 can also be cameras with other zoom ratios as long as the two cameras of the image shooting module 110 have different zoom ratios.

The selection module 120 is configured to select a predetermined zoom ratio. In the present embodiment, a user can use the selection module 120 to select different zoom ratios, such as 1× zoom, 2× zoom or 3× zoom or greater, etc. The predetermined zoom ratio can be as same as a zoom ratio of any of the cameras of the image shooting module 110, and can also be greater than a zoom ratio of any of the cameras of the image shooting module 110.

The control module 130 is configured to control the image shooting module 110 to shoot according to the predetermined zoom ratio selected by the selection module 120.

When the predetermined zoom ratio is greater than a zoom ratio of any of the cameras of the image shooting module 110, the control module 130 controls the at least two cameras with different zoom ratios of the image shooting module to shoot a same scenario. When the selected predetermined zoom ratio is as same as a zoom ratio of one camera in the image shooting module 110, the control module 130 controls a corresponding camera in the image shooting module 110 to individually shoot so as to obtain an image with the predetermined zoom ratio.

In the present embodiment, when lx zoom is selected to shoot, the control module 130 can control a camera with lx zoom in the image shooting module 110 to shoot pictures. When 2× zoom is selected to shoot, the control module 130 can control a camera with 2× zoom in the image shooting module 110 to shoot. When 3× zoom or greater is selected, the control module 130 controls the two cameras to simultaneously shoot a same scenario, so as to obtain images with two different zoom ratios. Because the two cameras shoot the same scenario at a same time and the two cameras are close to each other, an image shot by the camera with 2× zoom basically occurs in an image shot by the camera with lx zoom.

The region selection module 140 is configured to determine image regions corresponding to an image with the predetermined zoom ratio in images with different zoom ratios obtained by the image shooting module 110 according to the predetermined zoom ratio of an image to be obtained when the control module 120 controls the at least two cameras with different zoom ratios of the image shooting module 110 to shoot a same scenario; and the predetermined zoom ratio is greater than a zoom ratio of any of the cameras of the image shooting module 110.

In the present embodiment, the cameras of the image shooting module 110 respectively have 1× zoom and 2× zoom. Because the two cameras shoot the same scenario at the same time, an image obtained by 1× zoom has a large scene shooting range, while the camera with 2× zoom has a scene shooting range less than the scene shooting range of 1× zoom. If an image of 3× zoom is desired, the image obtained by 3× zoom has a smaller image shooting range, that is, an image obtained by 3× zoom shall be a part of an image obtained by 1× zoom and an image obtained by 2× zoom. The region selection module 140 is configured to determine an image region selected from an image of lx zoom and a corresponding region selected from an image of 2× zoom when an image of 3× zoom is desired. The corresponding region means that image contents in the image region selected from the image of 1× zoom are as same as contents in the image region selected from the image of 2× zoom.

The synthesis module 150 is configured to synthesize image regions corresponding to an image with the predetermined zoom ratio determined in images with different zoom ratios by the region selection module 140, so as to obtain an image with a zoom ratio greater than the zoom ratios of the cameras of the image shooting module 110. The synthesis module 150 is specifically configured to synthesize a plurality of low-resolution photos into a high-resolution photo by adopting a super resolution image reconstruction technology. Specifically, the synthesis module 150 can synthesize an image region selected from an image of 1× zoom and a corresponding image region selected from an image of 2× zoom by adopting an image synthesis algorithm such as the super resolution image reconstruction technology, so as to obtain an image of 3× zoom.

Because contents of the image of 3× zoom are only a part of the corresponding image of 1× zoom or image of 2× zoom, sizes of the image region selected from the image of 1× zoom and the corresponding image region selected from the image of 2× zoom are less than those of an original image of 1× zoom and an original image of 2× zoom. When the image region selected from the image of 1× zoom and the corresponding image region selected from the image of 2× zoom are amplified to a size of a synthesized image, resolution of the image region selected from the image of 1× zoom will be less than that of the original image of 1× zoom and resolution of the corresponding image region selected from the image of 2× zoom will be less than that of the original image of 2× zoom. After synthesized, an obtained image of 3× zoom has a higher resolution. With respect to a working mechanism of the synthesis module 150, an existing image synthesis process can be adopted, and will not be repeated herein.

The conversion module 160 is configured to convert an image synthesized by the synthesis module 150 into an image with predetermined resolution. After the synthesis module 150 conducts synthesis, the synthesized image may have a resolution different from that of an image desired by the user, and the conversion module 160 can convert resolution of the image, so as to obtain the image with resolution required by the user. The conversion module can convert an image obtained by the synthesis module 150 into an image with the predetermined resolution by adopting an image difference algorithm, etc. In the present embodiment, an image obtained by the synthesis module 150 can be converted into an image of 13 MP.

It can be understood that the image shooting terminal 100 can further include a correction module. Since there is a distance between the two cameras of the image shooting module 110, images obtained by shooting the same scenario at the same time by the two cameras may be deviated. The correction module can correct the obtained images according to the distance and a position relationship between the two cameras, so that centers of two patterns can overlap.

The image shooting terminal 100 can also include a storage module configured to store high-resolution photos. Specifically, the storage module is configured to store images converted by the conversion module 160 or images synthesized by the synthesis module 150 for users to use subsequently; the storage module can also simultaneously store low-resolution photos prior to synthesis of the synthesis module, so as to allow users to select and use low-resolution photos and/or high-resolution photos according to actual needs for other operations; for example, low-resolution photos are used when transmitting a multimedia message, and high-resolution photos are used when making a front cover.

In the present embodiment, if both of the two cameras have pixel of 13 MP, a thickness of the camera of 1× zoom is about 5.1 mm and a thickness of the camera of 2× zoom is about 6.5 mm when a focal distance of the camera of 1× zoom is set as 3.5 mm and a focal distance of the camera of 2× zoom is set as 6.8 mm, so that a thickness of an obtained image shooting module can only be determined according to the camera with a larger thickness. In other embodiments, to have a smaller thickness of the image shooting module 110, it can be realized in such a manner that two cameras with different resolutions are matched. The camera with a lower resolution can be adopted as a camera with a higher zoom ratio, and the camera with a higher resolution can be adopted as a camera with a lower zoom ratio. For the camera with the higher resolution, an image sensor adopted by the camera has a larger size, while for the camera with the lower resolution, an image sensor adopted by the camera has a smaller size. Specifically, the camera with a resolution of 13 MP can be adopted for 1× zoom, and has a thickness of about 5.1 mm, while the camera with a resolution of 8 MP can be adopted for 2× zoom, and also has a thickness of about 5.1 mm; in this way, the two cameras of the image shooting module 110 may have an approximately same thickness, so as to reduce an overall thickness of the image shooting module 110.

It can be understood that the image shooting terminal 100 can also not include the conversion module 160; and when users has no requirement for resolution of a formed image, an image synthesized by the synthesis module 150 can be directly obtained. The image shooting terminal 100 can also not include the selection module 120, and the image shooting terminal 100 can obtain an image with a zoom ratio greater than zoom ratios of the cameras of the image shooting module 110 by default.

The image shooting terminal 100 provided in the present embodiment adopts images obtained by the image shooting module 110 with a low zoom ratio to conduct synthesis so as to obtain an image with a higher zoom ratio. Because the image shooting module 110 adopts cameras with a lower zoom ratio, a thickness of the image shooting module 110 can be reduced, thereby solving a problem in an existing technology in which a camera with a complicated structure is adopted to obtain an image with a high zoom ratio.

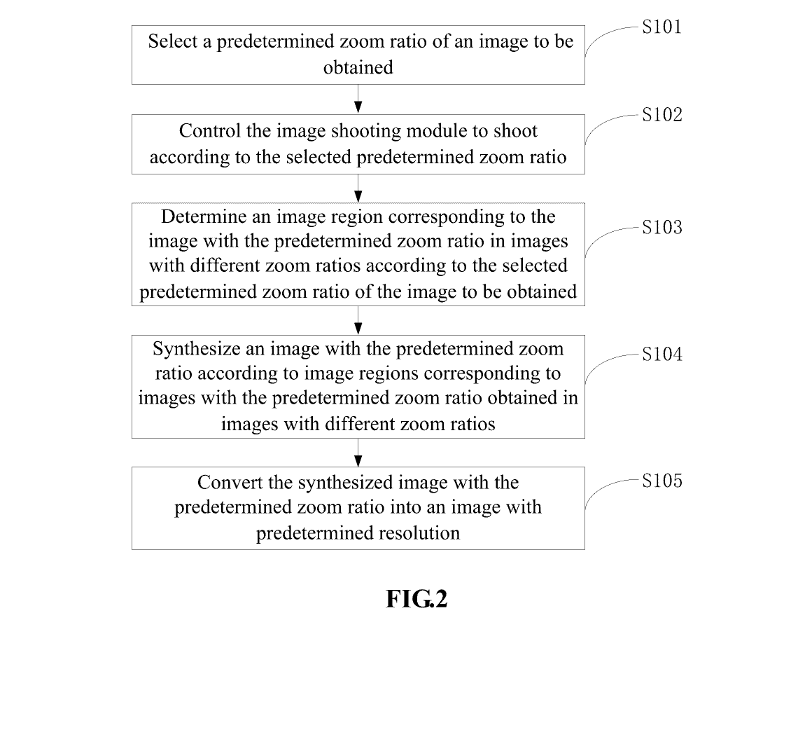

With reference to FIG. 2, the technical solution also correspondingly provides an image shooting method. The image shooting method can be completed by adopting the image shooting terminal 100, and the image shooting method includes steps S101 to S104.

In S101, a predetermined zoom ratio of an image to be obtained is selected.

The predetermined zoom ratio of the image to be obtained can be selected as needed. Specifically, the selection module 120 is adopted to select the predetermined zoom ratio of the image to be obtained; and the predetermined zoom ratio of the image to be obtained can be as same as a zoom ratio of one camera of the image shooting module 110, and can also be greater than zoom ratios of cameras of the image shooting module 110.

In S102, the image shooting module is controlled to shoot according to the selected predetermined zoom ratio.

When the selected predetermined zoom ratio of the image to be obtained is as same as a zoom ratio of one camera in the image shooting module 110, the corresponding camera can be controlled to shoot a scenario and obtain an image, so as to complete image shooting.

When the selected predetermined zoom ratio of the image to be obtained is greater than zoom ratios of the cameras of the image shooting module 110, the cameras with different zoom ratios of the image shooting module may be controlled to synchronously shoot to respectively obtain images with different zoom ratios, and then enters step S103.

In S103, an image region corresponding to the image with the predetermined zoom ratio are determined in images with different zoom ratios according to the selected predetermined zoom ratio of the image to be obtained.

In the present embodiment, the cameras of the image shooting module 110 respectively have 1× zoom and 2× zoom. Because the two cameras shoot the same scenario at the same time, an image obtained by 1× zoom has a large scene shooting range, while the camera with 2× zoom has a scene shooting range less than the scene shooting range of 1× zoom. If an image of 3× zoom is desired, the image obtained by 3× zoom has a smaller image shooting range, that is, an image obtained by 3× zoom shall be a part of an image obtained by 1× zoom and an image obtained by 2× zoom. An image region selected from an image of 1× zoom and a corresponding region selected from an image of 2× zoom are determined when an image of 3× zoom is desired. The corresponding region means that image contents in the image region selected from the image of 1× zoom are as same as contents in the image region selected from the image of 2× zoom.

In S104, an image with the predetermined zoom ratio is synthesized according to image regions corresponding to images with the predetermined zoom ratio obtained in images with different zoom ratios.

Two images can be synthesized by adopting an image synthesis algorithm such as the super resolution image reconstruction technology.

It can be understood that, after S102 and prior to S103, images with different zoom ratios are corrected, so as to overlap centers of at least two images with different zoom ratios. In the present embodiment, correction can be performed according to distances and position relationships among a plurality of cameras of the image shooting module 110.

After S104, S105 can also be included, in which the synthesized image with the predetermined zoom ratio is converted into an image with predetermined resolution.

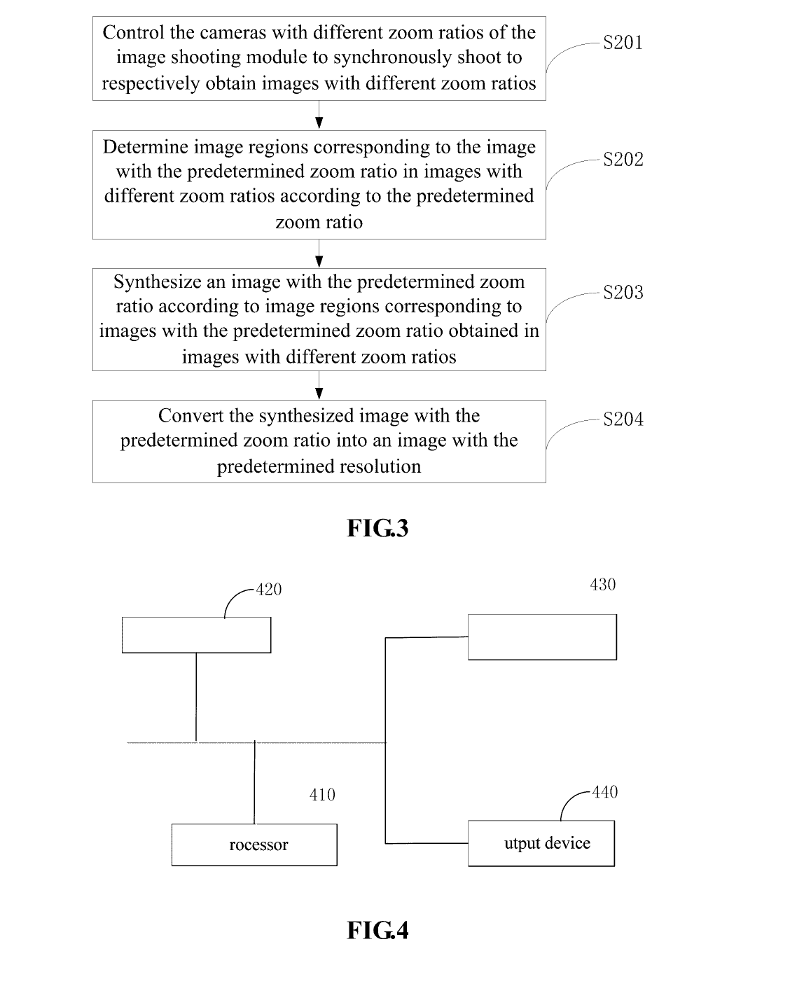

With reference to FIG. 3, in an image shooting method provided in another embodiment of the technical solution, if only an image with the predetermined zoom ratio greater than zoom ratios of the cameras of the image shooting module is to be obtained, an image shooting method includes steps S201 to S203.

In S201, the cameras with different zoom ratios of the image shooting module are controlled to synchronously shoot to respectively obtain images with different zoom ratios.

In S202, image regions corresponding to the image with the predetermined zoom ratio are determined in images with different zoom ratios according to the predetermined zoom ratio.

In S203, an image with the predetermined zoom ratio is synthesized according to image regions corresponding to images with the predetermined zoom ratio obtained in images with different zoom ratios.

After S203, S204 can also be included, in which the synthesized image with the predetermined zoom ratio is converted into an image with the predetermined resolution.

The image shooting method provided in the present embodiment adopts images obtained by the image shooting module with a low zoom ratio to conduct synthesis so as to obtain an image with a higher zoom ratio. Because the image shooting module adopts cameras with a lower zoom ratio, a thickness of the image shooting module can be reduced, thereby solving a problem in an existing technology in which a camera with a complicated structure is adopted to obtain an image with a high zoom ratio.

Embodiments of the present disclosure provide a non-volatile computer storage medium, where a computer executable instruction is stored in the computer storage medium, and the computer executable instruction can be used for executing any method for shooting image in embodiments of the present disclosure.

FIG. 4 is a schematic diagram illustrating a hardware structure of an image shooting terminal for shooting image in one embodiment of the technical solution. As shown in FIG. 4, the image shooting terminal includes:
at least one processor 410 and a memory 420, and in FIG. 4, one processor 410 is taken as an example.

The device for executing the method for shooting image can also include: an input device 430 and an output device 440.

The processor 410, the memory 420, the input device 430 and the output device 440 can be connected by a bus or in other modes, and connecting by the bus is taken as an example in FIG. 4.

As a non-volatile computer readable storage medium, the memory 420 may be used for storing non-volatile software programs, non-volatile computer executable programs and modules, such as program instructions/modules (e.g., modules shown in FIG. 1) corresponding to the method for shooting image in embodiments of the present disclosure. The processor 410 executes all kinds of function application and data processing of the server by operating the non-volatile software programs, the instructions and the modules stored in the memory 420, thereby realizing the method for shooting image in the above method embodiments.

The memory 420 may include a program storage area and a data storage area, where the program storage area can store an operating system and applications required for at least one function; and the data storage area may store data and the like created according to use of the device for shooting image. In addition, the memory 420 may include a high-speed random access memory, and may also include a non-volatile memory, such as at least one disk memory device, a flash memory device or other non-volatile solid-state memory devices. In some embodiments, the memory 420 may selectively include memories remotely arranged relative to the processor 410, where the remote memories may be connected to the device for shooting image by a network. An example of the above network includes but not limited to Internet, Intranet, local area network, mobile communication network and a combination thereof.

The input device 430 may be used for receiving inputted digit or character information, and producing key signal input related to the user setting and function control of the device for shooting image. The output device 440 may include a display screen and other display devices.

The at least one module is stored in the memory 420, and executes the method for shooting image in any of the above method embodiments when being executed by the at least one processor 410.

The above-mentioned product can execute the method provided in embodiments of the present disclosure, and has a corresponding function module for executing the method and beneficial effects. See the method provided in embodiments of the present disclosure for technical details not described in the embodiments in detail.

The image shooting terminal in embodiments of the present disclosure exists in many forms, and includes but not limited to:
(1) a mobile communication device: such device has the characteristics of having a mobile communication function and a primary objective to provide voice and data communication; such terminal includes: an intelligent mobile phone (such as iPhone), a multimedia mobile phone, a functional mobile phone, a low-end mobile phone and the like;
(2) an ultra-mobile personal computer device: such device belongs to a category of personal computers, has functions of calculation and processing and generally has a characteristic of mobile networking; such terminal includes: PDA, MID, UMPC device and the like, such as iPad;
(3) a portable recreational device: such device can display and play multimedia contents; such device includes: an audio and video player (such as iPod), a handheld game player, an electronic book, an intelligent toy and a portable vehicle navigation device;
(4) a server: the server is a device that provides a calculation service; a structure of the server includes a processor, a hard disk, a memory, a system bus and the like; the server is similar to a universal computer architecture; however, because a high-reliability service is required to be supplied, requirements for processing capability, stability, reliability, safety, expandability, manageability and the like are high; and
(5) other electronic devices having a data interaction function.

The device embodiments described above are only illustrative, where a unit described as a separated component may be or may not be separated physically, and a component displayed as a unit may be or may not be a physical unit, that is, the components can be located at one place or can be distributed on a plurality of network units. The solution of the embodiments can be achieved by selecting some or all of modules according to actual needs. Those ordinary skilled in the art can understand and implement the solution without contributing creative labor.

By the description of the above embodiments, those skilled in the art can clearly understand that each embodiment can be achieved in the manner of using software and a common hardware platform, and of course, can also be achieved using hardware. Based on such understanding, the above technical solution can be reflected in a form of a software product in essence or in a part of making a contribution to the related art. The computer software product can be stored in the computer readable storage medium, such as an ROM/RAM, a magnetic disc, a CD and the like, including several instructions to enable one computer device (may be a personal computer, a server or a network device and the like) to execute the methods of various embodiments or some parts of the embodiments.

Of course, the present disclosure can also have various other embodiments, and various corresponding variations and deformations can be made by those skilled familiar with the art according to the present disclosure without departing from the spirit and essence of the present disclosure, but these corresponding variations and deformations should belong to the protection scope of appended claims of the present disclosure.

What is claimed is:

1. An image shooting terminal, comprising:
at least one processor; and
a memory communicably connected with the at least one processor for storing instructions executable by the at least one processor;
wherein, execution of the instructions by the at least one processor causes the at least one processor to:
control at least two cameras with different zoom ratios to shoot a scenario;
determine image regions corresponding to an image with a predetermined zoom ratio in images with different zoom ratios obtained by the at least two cameras according to the predetermined zoom ratio when controlling the at least two cameras with different zoom ratios to shoot a same scenario and when an image to be obtained has a predetermined zoom ratio greater than a zoom ratio of any of the cameras; and
synthesize image regions corresponding to the image with the predetermined zoom ratio determined in images with different zoom ratios, so as to obtain an image with the predetermined zoom ratio.

2. The image shooting terminal according to claim 1, wherein, the execution of the instructions by the at least one processor further causes the at least one processor to select the predetermined zoom ratio.

3. The image shooting terminal according to claim 2, wherein, the execution of the instructions by the at least one processor causes the at least one processor to:
control a corresponding camera to individually shoot when the selected predetermined zoom ratio is as same as a zoom ratio of one camera in the at least two cameras, so as to obtain the image with the predetermined zoom ratio.

4. The image shooting terminal according to claim 2, wherein, the execution of the instructions by the at least one processor causes the at least one processor to:
control the at least two cameras with different zoom ratios to shoot a same scenario when the selected predetermined zoom ratio is different from a zoom ratio of any of the cameras.

5. The image shooting terminal according to claim 1, wherein, the execution of the instructions by the at least one processor further causes the at least one processor to:
convert the synthesized image into an image with a predetermined resolution.

6. The image shooting terminal according to claim 1, wherein, the execution of the instructions by the at least one processor further causes the at least one processor to:
perform position correction to images with different focal distances shot by the at least two cameras according to distances and position relationships among a plurality of cameras.

7. The image shooting terminal according to claim 1, wherein, the at least two cameras with different zoom ratios have a same resolution.

8. The image shooting terminal according to claim 1, wherein, the at least two cameras are two cameras having different resolutions, and one of the cameras with a higher resolution has a zoom ratio less than a zoom ratio of the other camera with a lower resolution.

9. A non-transitory computer-readable storage medium storing executable instructions that, when executed by an image shooting terminal, cause the image shooting terminal to:
control at least two cameras with different zoom ratios to shoot a scenario;
determine image regions corresponding to an image with a predetermined zoom ratio in images with different zoom ratios obtained by the at least two cameras according to the predetermined zoom ratio when controlling the at least two cameras with different zoom ratios to shoot a same scenario and when an image to be obtained has a predetermined zoom ratio greater than a zoom ratio of any of the cameras; and
synthesize image regions corresponding to the image with the predetermined zoom ratio determined in images with different zoom ratios, so as to obtain an image with the predetermined zoom ratio.

10. The non-transitory computer-readable storage medium according to claim 9, wherein, the executable instructions further cause the image shooting terminal to select the predetermined zoom ratio.

11. The non-transitory computer-readable storage medium according to claim 10, wherein, the executable instructions cause the image shooting terminal to:
control a corresponding camera to individually shoot when the selected predetermined zoom ratio is as same as a zoom ratio of one camera in the at least two cameras, so as to obtain the image with the predetermined zoom ratio.

12. The non-transitory computer-readable storage medium according to claim 10, wherein, the executable instructions cause the image shooting terminal to:
control the at least two cameras with different zoom ratios to shoot a same scenario when the selected predetermined zoom ratio is different from a zoom ratio of any of the cameras.

13. The non-transitory computer-readable storage medium according to claim 9, wherein, the executable instructions further cause the image shooting terminal to:
convert the synthesized image into an image with a predetermined resolution.

14. The non-transitory computer-readable storage medium according to claim 9, wherein, the executable instructions further cause the image shooting terminal to:
perform position correction to images with different focal distances shot by the at least two cameras according to distances and position relationships among a plurality of cameras.

15. The non-transitory computer-readable storage medium according to claim 9, wherein the at least two cameras with different zoom ratios have a same resolution.

16. The non-transitory computer-readable storage medium according to claim 9, wherein the at least two cameras are two cameras having different resolutions, and one of the cameras with a higher resolution has a zoom ratio less than a zoom ratio of the other camera with a lower resolution.

17. An image shooting method, comprising:
controlling at least two cameras with different zoom ratios of an image shooting module to synchronously shoot to respectively obtain images with different zoom ratios;
determining image regions corresponding to an image with a predetermined zoom ratio in images with different zoom ratios according to the predetermined zoom ratio of an image to be obtained, wherein the predetermined zoom ratio is greater than a zoom ratio of any of the cameras of the image shooting module; and
synthesizing an image with the predetermined zoom ratio according to image regions corresponding to images with the predetermined zoom ratio obtained in images with different zoom ratios.

18. An image shooting method, comprising:
selecting a predetermined zoom ratio of an image to be obtained;
controlling an image shooting module to shoot according to the selected predetermined zoom ratio; and
determining image regions corresponding to the image with the predetermined zoom ratio in images with different zoom ratios according to the predetermined zoom ratio of the selected and obtained image when the predetermined zoom ratio is greater than a zoom ratio of any of the cameras of the image shooting module.
